(19) United States
(12) Patent Application Publication
(10) Pub. No.: US 2007/0235485 A1
(43) Pub. Date: Oct. 11, 2007

(54) SYSTEM FOR MOUNTING AN AUTOMOTIVE ACCESSORY

(75) Inventors: Scott Aaron Ford, Belleville, MI (US); Michael Ford, West Bloomfield, MI (US); Travis Steven Garland, Dearborn, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/308,466

(22) Filed: Mar. 28, 2006

(51) Int. Cl. B60R 9/00; B60R 11/00

(52) U.S. Cl. 224/315; 224/326; 224/557

(57) ABSTRACT

A system for mounting an accessory to an automotive vehicle includes at least one shoulder fastener having a shank and a head extending above the vehicle surface. A mounting base for an accessory has an aperture permitting the mounting base to lock upon the shoulder fastener. A retainer prevents the mounting base from slidably disengaging from shoulder fastener once the base has been locked upon the shoulder fastener.

### TECHNICAL FIELD

The present invention relates to a system for mounting an accessory such as a roof rack upon an automotive vehicle, without the need for externally accessible fasteners.

### BACKGROUND

Automotive vehicle accessories such as emergency light bars, roof racks, luggage racks, and other devices, have traditionally been mounted and retained by means of externally accessible fasteners. Unfortunately, such fasteners often result in an unsightly appearance associated with exposed screw heads, or undesirable complexity occasioned by the need for covers to hide installed screws. U.S. Pat. No. 6,182,876 discloses a utility rack system having an external fastening system of the type generally found in the prior art.

The present system allows the mounting of an automotive accessory such as a roof rack without the need for externally visible or accessible fasteners.

### SUMMARY

A system for mounting an accessory to an automotive vehicle includes at least one shoulder fastener having a shank and a head joined with the shank, with a portion of the shank and head adapted to extend from the vehicle surface. A mounting base, which is adapted for integration with an automotive accessory, engages the vehicle surface and the shoulder fastener. An aperture formed in the mounting base has an entry portion permitting passage of the head and shank of the shoulder fastener, and a locking portion permitting passage of only the shank. The present system also includes a retainer which is mounted to the base. The retainer allows slidable engagement of the base with the shoulder fastener. The retainer has a first position for engaging an upper surface of the fastener head when the head and shank and are within the entry portion of the aperture, and a second position for engaging the shank alone when the head and shank are within the locking portion of the aperture. The retainer preferably comprises a mounting bracket attached to the base and having a sprag cantilevered from the mounting bracket.

The present system is ideally suited for mounting a roof rack to the external surface of the vehicle roof. Such a roof rack may include longitudinally extending roof rails intersected by laterally extending roof rails, and a number of mounting pedestals attached to the longitudinally extending rails at end portions of the rails. Each of the mounting pedestals includes the previously described mounting base having an interior cavity formed within the base, and having a lower wall for contacting a vehicle roof or other surface. An aperture is formed in the lower wall of the mounting base, with the aperture having a keyhole configuration with the previously described entry and locking portions.

According to another aspect of the present invention, a method for mounting an accessory to a surface of an automotive vehicle includes the steps of providing a plurality of shoulder fasteners mounted to the surface, with each fastener having a shank and a head extending from the surface, and providing at least one mounting pedestal including a base with a lower wall for slidingly engaging both the shoulder fasteners and the surface. The method further includes placing at least one of the mounting pedestals over a plurality of shoulder fasteners such that the lower wall of the mounting pedestal comes into contact with the surface so as to cause the shoulder fasteners to extend into entry portions of keyhole apertures formed in the lower wall. Finally, the method includes sliding the pedestal upon the surface such that a shank portion of each of the shoulder fasteners becomes engaged with a locking portion of the keyhole aperture and with a latch sprag mounted within the base.

It is an advantage of a system according to the present invention that an accessory may be mounted upon an automotive vehicle without the need for any externally visible fasteners.

It is a further advantage of a system according to the present invention that an accessory may be mounted to an automotive vehicle without the need for any installation tools.

It is a further advantage of a system according to the present invention that accessory design may be simplified through the use of the present invention because of the ability to fasten an accessory without the need for external covers to hide fasteners.

It is a further advantage of a system according to the present invention that the unsightly appearance caused by exposed fasteners is avoided without engendering additional cost.

Other advantages, as well as objects and features of the present invention will become apparent to the reader of this specification.

### BRIEF DESCRIPTION OF THE DRAWINGS

FIG. 1 is a perspective view of an automotive vehicle having a roof rack using a mounting system according to the present invention.

FIG. 2 is a downward looking plan view of a portion of a mounting pedestal, 26, incorporated in a roof rack, 14, as shown in FIG. 1.

FIG. 3 is similar to FIG. 2 but shows a bottom plan view of a pedestal, 26, incorporated in a roof rack according to the present invention.

FIG. 4 is similar to FIG. 3, but shows a shoulder bolt fastener cutaway so as to expose the full extent of a locking aperture formed in lower wall 58 of the present mounting system.

FIG. 5 is a side view of the present mounting system during an initial stage of installation of a device incorporating the system.

FIG. 6 illustrates a mounting system in a fully locked and installed position.

### DETAILED DESCRIPTION OF THE PREFERRED EMBODIMENTS

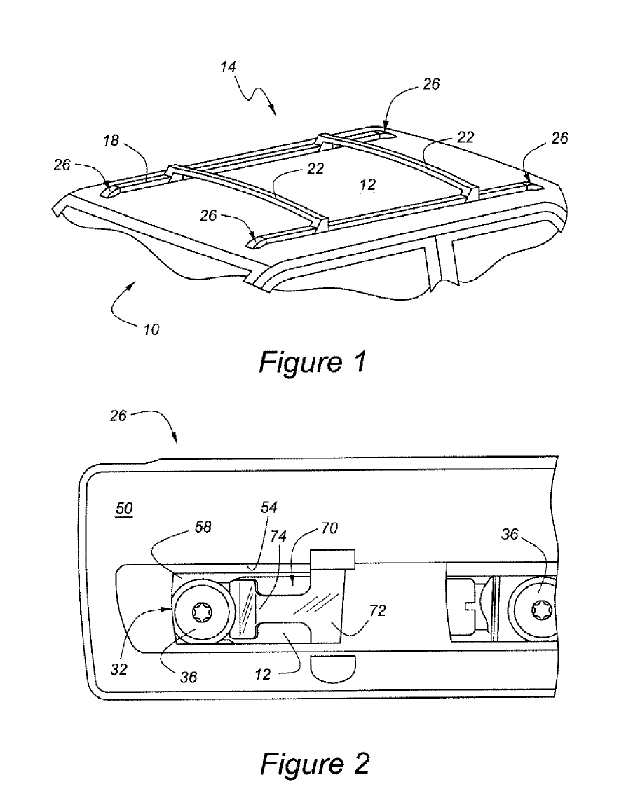

AS shown in FIG. 1, vehicle 10 has outer roof panel 12, with roof rack 14 installed thereupon. Roof rack 14 includes longitudinally extending rails 18 and laterally extending rails 22, which are mounted to and carried upon longitudinally extending rails 18. Mounting pedestals 26 are found at end portions of longitudinally extending rails 18. FIGS. 2, 3, 4, 5, and 6 all illustrate various design features of mounting pedestals 26.

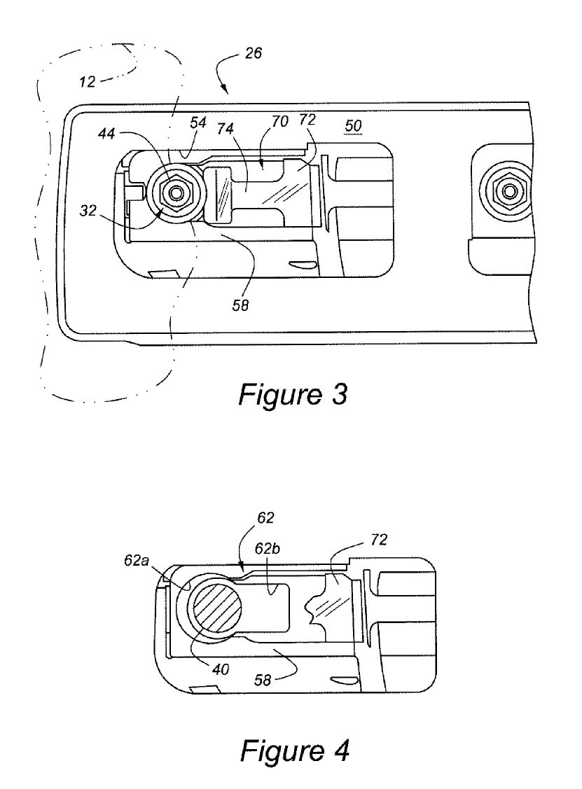

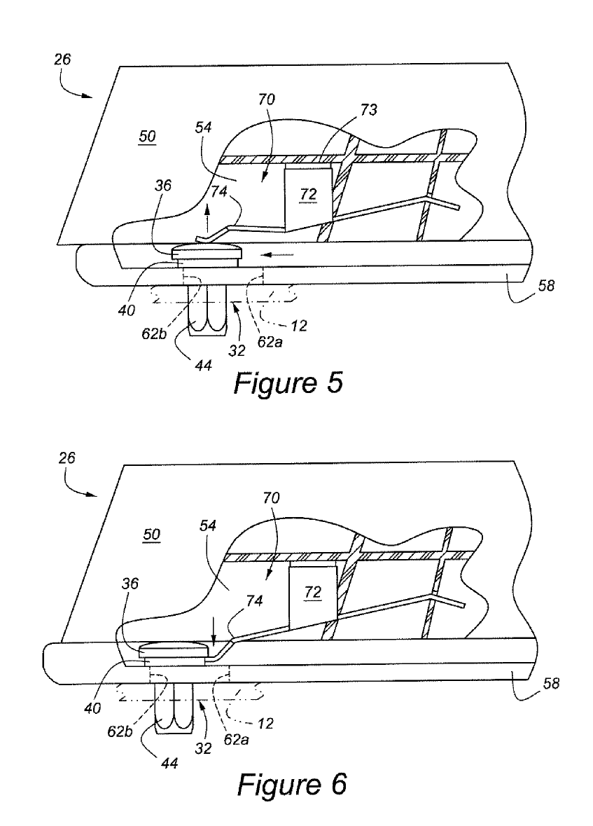

FIGS. 5 and 6 show an exemplary profile for shoulder fastener 32 which is useful for practicing the present invention. Each of shoulder fasteners 32 has a head, 36, which is joined with a shank, 40. A portion of shank 40 and the entirety of head 36 extend from vehicle top panel 12, as shown in FIGS. 5 and 6. Shoulder fastener 32 is maintained in its location with respect to panel 12 by means of threaded fastener 44. FIGS. 3, 5, and 6 depict fastener 44 as a hex fastener, but other types of fasteners known to those skilled in the art and suggested by this disclosure may be employed with the present invention. Also, the precise configuration of shoulder fastener 32 may be selected according to the dictates of any particular application of the present invention.

FIGS. 2, 3, and 6 illustrate the locked position of retainer 70, which has a bracket 72 that is attached to base 50 of mounting pedestal 26. Bracket 72 is shown in side view in FIG. 6. Bracket 72 has a sprag or latch, 74, cantilevered from the one side of bracket 72, which is itself mounted to interior wall 73 of base 50 (FIG. 6). In its final position, sprag 74, as shown in FIGS. 2, 3, and 6, locks under head 36 of shoulder fastener 32 and abuts shank 40 of shoulder fastener 32. Thus, when sprag 74 is the position shown in FIGS. 2, 3, and 6, an automotive accessory to which the present mounting system is attached cannot be released and removed by sliding the mounts backward.

The function of sprag 74 may further be understood with reference to FIGS. 4, 5, and 6. As shown in FIG. 4, keyhole aperture 62 has entry portion 62a and shank portion 62b. When mounting pedestal 26 is placed downwardly onto shoulder fastener 32, sprag 74 is displaced upwardly by shoulder fastener 32, as shown in FIG. 5. At this point, shoulder fastener 32 is extending upwardly through entry portion 62a of keyhole aperture 62. Then, as pedestal 26 is slidingly moved in the direction F of FIG. 4, shoulder fastener 32, and more specifically, shank portion 40 of shoulder fastener 52, will move to the locking portion, 62b, of aperture 62. Once shoulder fastener 32 is in the locking position shown in FIGS. 2, 3, and 6, sprag 74 is effectively trapped under head 36 of shoulder fastener 32 so that pedestal 26 cannot be moved in the direction opposite to the direction of installation.

FIGS. 5 and 6 show that pedestal 26 has base 50 with cavity 54 which is closed by lower wall 58. Wall 58 serves the principal function of providing location for keyhole aperture 62, while also providing a surface for slidingly engaging the surface upon which an accessory is to be mounted with the present system.

While particular embodiments of the invention have been shown and described, numerous variations and alternate embodiments will occur to those skilled in the art. Accordingly, it is intended that the invention be limited only in terms of the appended claims.

What is claimed is:

1. A system for mounting an accessory to an automotive vehicle, comprising:
at least one shoulder fastener having a shank and a head joined with said shank, with a portion of said shank and said head adapted to extend from a vehicle surface;
a mounting base for engaging said vehicle surface, with said mounting base being adapted for integration with an automotive accessory;
an aperture formed in said mounting base, with said aperture having an entry portion permitting passage of said head and said shank and a locking portion permitting passage only of said shank; and
a retainer, mounted to said base, for slidable engagement with said shoulder fastener, with said retainer having a first position for engaging an upper surface of said fastener head when said head and shank are within said entry portion of said aperture, and a second position for engaging said shank when said head and shank are within the locking portion of said aperture.

2. A system according to claim 1, wherein said aperture has a keyhole configuration.

3. A system according to claim 1, wherein said retainer comprises a mounting bracket attached to said base and having a sprag cantilevered from said mounting bracket.

4. A system according to claim 1, wherein said mounting base is attached to a roof rack.

5. A system according to claim 1, wherein said vehicle surface comprises an external surface of a roof.

6. A system for mounting an accessory to an automotive vehicle, comprising:
a mounting base adapted for engagement with a vehicle surface, with said mounting base being adapted for integration with an automotive accessory;
an aperture formed in said mounting base, with said aperture having a keyhole configuration with an entry portion adapted to permit passage of a head and shank portion of a shoulder fastener mounted to and extending from a surface of an automotive vehicle, and a locking portion adapted to permit passage of only said shank portion of a said shoulder fastener; and
a retainer, mounted to said base, adapted for slidable engagement with said shoulder fastener, with said retainer having a first position for engaging the head portion of said shoulder fastener, and a second position for engaging the shank portion of the shoulder fastener when the shank portion of a shoulder fastener is positioned within the locking portion of said aperture.

7. A roof rack for an automotive vehicle, comprising:
a plurality of longitudinally extending roof rails;
a plurality of laterally extending rails attached to said longitudinally extending rails; and
a plurality of mounting pedestals attached to said longitudinally extending rails at end portions thereof, with each of said mounting pedestals comprising:
a mounting base attached to at least one of said longitudinally extending rails, with the mounting base being adapted for engagement with a vehicle roof surface;
an interior cavity formed within said mounting base and having a lower wall for contacting a vehicle roof;
an aperture formed in said lower wall, with said aperture having a keyhole configuration with an entry portion adapted to permit passage of a head and shank portion of a shoulder fastener mounted to and extending from a surface of an automotive vehicle roof, and a locking portion adapted to permit passage of only said shank portion of a said shoulder fastener; and
a retainer, mounted to said base within said cavity, with the retainer being adapted for slidable engagement with said shoulder fastener, with said retainer having at least a first position for engaging the head portion of a shoulder fastener extending though the entry portion of said aperture, and a second position for engaging the shank portion of the shoulder fastener positioned within the locking portion of said aperture.

8. A roof rack according to claim 7, wherein said retainer comprises a sprag cantilevered from a mounting bracket attached to a wall extending within said aperture.

9. A roof rack according to claim 7, further comprising a plurality of shoulder fasteners for engaging said apertures formed in said mounting pedestal bases, with each of said shoulder fasteners having a shank and head extending from a vehicle roof.

10. A method for mounting an accessory to a surface of an automotive vehicle, comprising the steps of:
providing a plurality of shoulder fasteners mounted to the surface, with each fastener having a shank and a head extending from said surface;
providing at least one mounting pedestal comprising a base with a lower wall for slidingly engaging both said shoulder fasteners and said surface;
placing said at least one mounting pedestal over said plurality of shoulder fasteners such that said lower wall comes into contact with said surface, such that said shoulder fasteners extend into entry portions of a keyhole apertures formed in the lower wall; and
sliding said pedestal upon said surface such that a shank portion of each of the shoulder fasteners becomes engaged with a locking portion of the keyhole aperture and with a latch sprag mounted within the base.

11. A method according to claim 10, wherein said surface comprises an exterior roof panel.
